(19) United States
(12) Patent Application Publication
(10) Pub. No.: US 2016/0294037 A1
(43) Pub. Date: Oct. 6, 2016

(54) VEHICLE ANTENNA AND WINDOW PLATE INCLUDING THE VEHICLE ANTENNA

(71) Applicant: ASAHI GLASS COMPANY, LIMITED, Tokyo (JP)

(72) Inventors: Tatsuya OCHI, Tokyo (JP); Koichi SAITO, Tokyo (JP); Masaki ITO, Tokyo (JP); Satoshi TOKUNAGA, Tokyo (JP); Yuki KISHIMOTO, Tokyo (JP)

(73) Assignee: ASAHI GLASS COMPANY, LIMITED, Tokyo (JP)

(21) Appl. No.: 15/078,707

(22) Filed: Mar. 23, 2016

(30) Foreign Application Priority Data
Mar. 31, 2015 (JP) 2015-073469

(51) Int. Cl. H01Q 1/12

(52) U.S. Cl. CPC H01Q 1/1271

(57) ABSTRACT

A vehicle antenna included in a window plate mounted to an opening of a vehicle body. The vehicle antenna includes an antenna conductor, a power-feed part including a connection point. The antenna conductor and the power-feed part are positioned in a vicinity of an upper edge and arranged between a side edge of the opening and a center line of the window plate in a width direction. The antenna conductor includes a first linear element extending in a vertical direction and including upper and lower ends, the upper end being directly connected to the connection point or by way of a connection element, and a second linear element extending in a horizontal direction and connected to the first linear element at the lower end or a vicinity of the lower end. A length of the second linear element is greater than a length of the first linear element.

### BACKGROUND OF THE INVENTION

1. Field of the Invention

The present invention generally relates to, for example, a vehicle antenna to be mounted to a window plate of a vehicle for receiving vertical polarized waves, and a window plate including the antenna.

2. Description of the Related Art

In a case of mounting a glass antenna to a vehicle glass, the shape of the glass antenna is preferred to be inconspicuous, so that a passenger's view can be prevented from being blocked by the glass antenna.

Conventionally, there is known a vehicle glass antenna that can receive Digital Audio Broadcasting (DAB). The DAB is constituted by two different frequency bands, one being a 174-240 MHz band (Band III) and the other being a 1452-1492 MHz band (L-band).

Because the DAB is polarized in a vertical direction, the vertical components of the DAB antenna include long patterns. For example, Japanese Laid-Open Patent Publication No. 2012-23707 discloses a window glass 11 provided with a glass antenna 55 including two antenna elements constituted by vertical patterns for receiving DAB that are polarized in the vertical direction and include two bands having separated frequencies.

However, in order to prevent the vehicle glass from blocking the passenger's view, the area for mounting the glass antenna is limited to an area proximal to the body of the vehicle. However, because the glass antenna is adversely affected when positioned proximal to the body of the vehicle made of metal or the like, it is difficult to design an antenna having a high reception gain.

Further, in Japanese Laid-Open Patent Publication No. 2012-23707, the glass antenna 55 including two antenna elements is mounted in a manner projecting from a black shielding film 14 provided at a periphery of the edge of a vehicle glass. Accordingly, the patterns of the glass antenna 55 could be clearly seen from both the inside and the outside of the vehicle and was visually unattractive.

In view of the above, one object according to an embodiment of the present invention is to provide a vehicle antenna and a window plate including the antenna for improving the appearance of the antenna mounted to the window plate and improving the gain for receiving vertical polarized waves of DAB.

### SUMMARY OF THE INVENTION

The present invention may provide a vehicle antenna and a window plate including the vehicle antenna that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a vehicle antenna and a window plate including the vehicle antenna particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a vehicle antenna included in a window plate mounted to an opening of a vehicle body of a vehicle, the vehicle antenna including a first antenna conductor, and a power-feed part including a first connection point. The first antenna conductor and the power-feed part are positioned in a vicinity of an upper edge part of the opening and arranged between a side edge part of the opening and a center line of the window plate in a width direction of the window plate. The first antenna conductor includes a first linear element extending in a vertical direction and including upper and lower ends, the upper end being directly connected to the first connection point or connected to the first connection point by way of a connection element, and a second linear element extending in a horizontal direction and connected to the first linear element at the lower end or a vicinity of the lower end. A length of the second linear element is greater than a length of the first linear element.

Other objects and further features of the present invention will be apparent from the following detailed description when read in conjunction with the accompanying drawings.

### BRIEF DESCRIPTION OF THE DRAWINGS

FIG. 1 is a plan view of a vehicle front window glass having an antenna provided therein according to a related art example;

FIG. 2 is a plan view illustrating an entire front window glass having an antenna provided therein according to an embodiment of the present invention;

FIG. 3 is a plan view of the front window glass illustrated in FIG. 2 in which a vehicle antenna and a ground are provided;

FIG. 4 is a plan view of a front window glass having a vehicle antenna provided therein according to a first embodiment of the present invention;

FIG. 5 is a plan view of a front window glass having a vehicle antenna provided therein according to a second embodiment of the present invention;

FIG. 6 is a plan view of a front window glass having a vehicle antenna provided therein according to a third embodiment of the present invention;

FIG. 7 is a plan view of a front window glass having a vehicle antenna provided therein according to a fourth embodiment of the present invention;

FIG. 8 is a schematic view of the entire front window glass illustrated in FIG. 7 in which a vehicle antenna and a camera are provided;

FIG. 9 is a plan view of a front window glass having a vehicle antenna provided therein according to a fifth embodiment of the present invention;

FIG. 10 is a plan view of a front window glass having a vehicle antenna provided therein according to a sixth embodiment of the present invention;

FIG. 11 is a plan view of a front window glass having a vehicle antenna provided therein according to a seventh embodiment of the present invention;

FIG. 12 is a table illustrating an average gain of a conventional antenna and an average gain of the antenna illustrated in FIG. 6;

FIG. 13 is a plan view of the entire front window glass provided in a vehicle antenna of the conventional example illustrated in the table of FIG. 12;

FIG. 14A is a table illustrating an antenna gain in each frequency of Band III in a case where the aspect ratio of the antenna of FIG. 4 is changed,

FIG. 14B is a graph corresponding to the table of FIG. 14A;

FIG. 15A is a graph illustrating an average gain with respect to a horizontal element length in a case where the aspect ratio of the antenna of FIG. 14A is changed;

FIG. 15B is a graph illustrating an average gain with respect to an aspect ratio in a case where the aspect ratio of the antenna of FIG. 14A is changed;

FIG. 16A is a graph illustrating an antenna gain in each frequency of Band III in a case where the aspect ratio of the antenna pattern is changed and conditions are different from those of FIGS. 14A-15B;

FIG. 16B is a table illustrating average values of the graph of FIG. 16A;

FIG. 17 is a graph illustrating a comparison of an antenna gain of each frequency in Band III with respect to the antenna of FIG. 5 and the antenna of FIG. 6;

FIG. 18 is a graph illustrating a comparison of an antenna gain of each frequency in Band III with respect to the antenna of FIG. 6 and the antenna of FIG. 7;

FIG. 19A is a graph illustrating an antenna gain of each frequency in Band III in a case where a branching position of an antenna pattern is changed and conditions are different from those of FIG. 18; and

FIG. 19B is a table illustrating the average values of the graph of FIG. 19A.

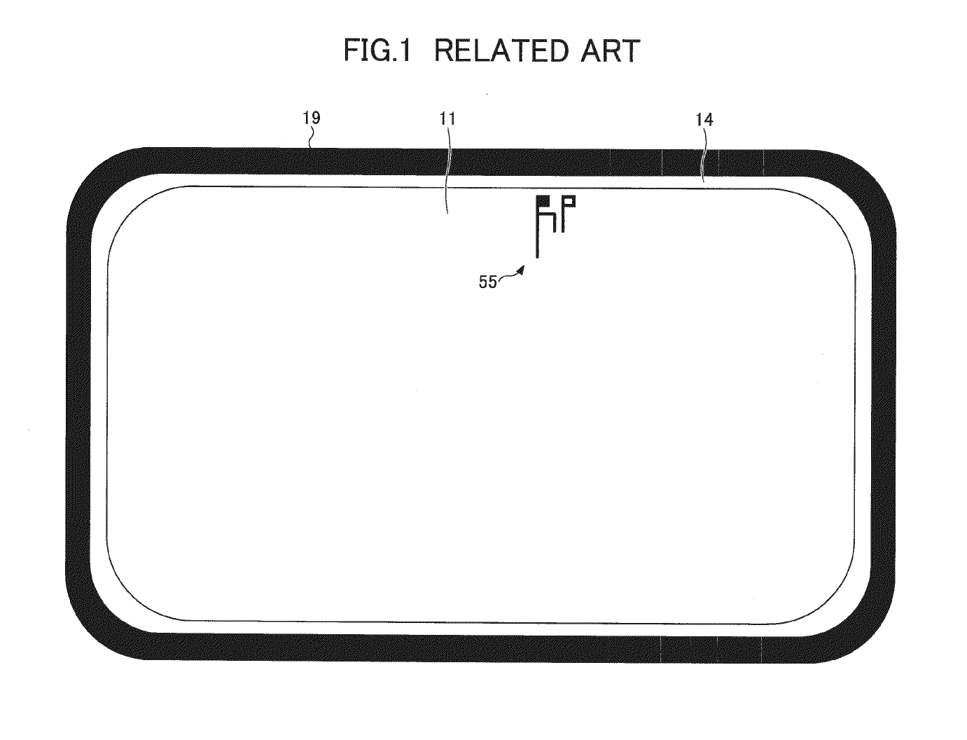

### DESCRIPTION OF THE PREFERRED EMBODIMENTS

In the following, embodiments of the present invention will be described with reference to the accompanying drawings. It is to be noted that directions in the below-described embodiments correspond to the directions in the drawings unless described as otherwise. The drawings are illustrated from a view observed from a side facing the surface of the window glass. Further, the drawings are vehicle inside views (or vehicle outside views) in a state where the window glass is attached to the vehicle. In the drawings, a lateral direction (right-left direction) corresponds to a horizontal direction and a longitudinal direction (up-down direction) corresponds to a vertical direction. Nevertheless, the drawings may also observed as vehicle outside views. For example, in a case of a front window glass having a window glass attached to the front of a vehicle, the lateral direction in the drawings corresponds to a width direction of the vehicle. Further, the window glass of the present invention is not limited to a front glass. For example, the window glass may be a rear glass attached to the rear of a vehicle or a side glass attached to the side of a vehicle. Further, directions such as a parallel direction and an orthogonal direction may somewhat be inaccurate to the extent of not degrading the effects of the present invention.

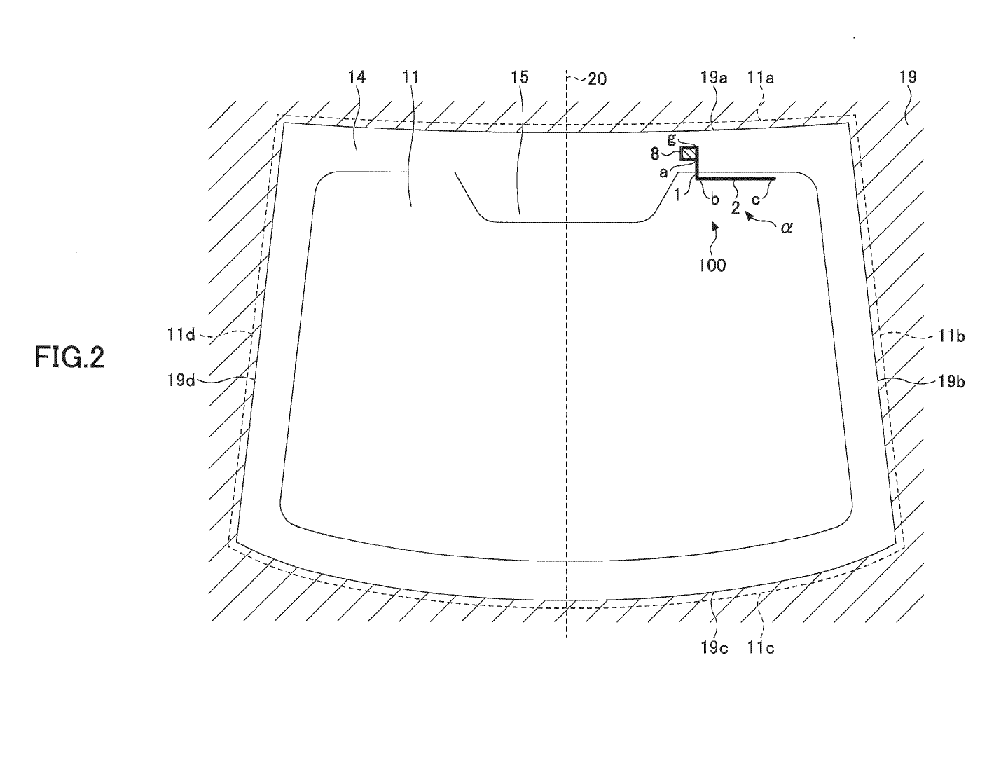

The window glass 11 of the present invention is one example of a window plate that covers an opening of a vehicle body. The material of the window plate is not limited to glass but may also be, for example, resin or a film-like material. The window glass 11 is attached to a body flange formed in a vehicle body (vehicle opening, body flange) 19. The outer peripheral edges 11a, 11b, 11c, and 11d of the window glass 11 are illustrated with dotted lines in FIG. 2. The vehicle body 19 includes end parts 19a, 19b, 19c, and 19d of a vehicle flange that forms a window opening of the vehicle.

FIG. 2 is a plan view of a glass antenna (example of a vehicle glass antenna) 100 according to an embodiment of the present invention. The vehicle antenna 100 is an antenna that is, for example, printed, embedded, or adhered to a window plate. The vehicle glass antenna 100 includes an electric power-feed part and an antenna conductor that are flatly provided on the vehicle window glass (window plate) 11 as conductor patterns.

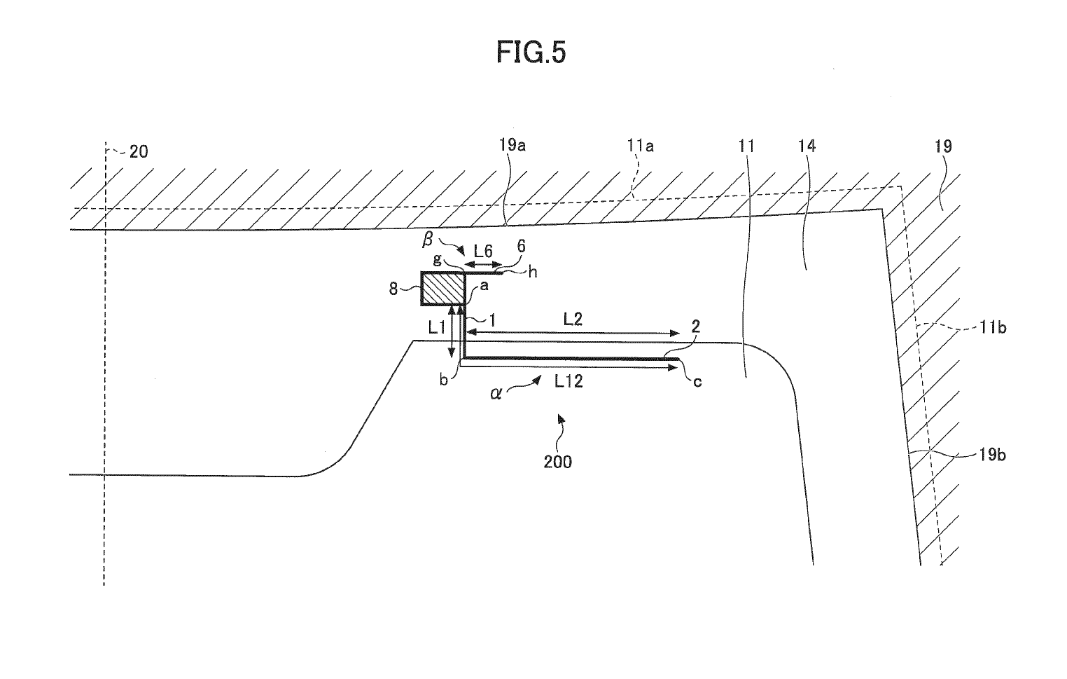

The glass antenna 100 includes an antenna element α used for Band III. The antenna element α includes an element (first linear element) 1 extending in a substantially vertical direction from a power-feed part 8 and an element (second linear element) 2 extending in a substantially horizontal direction from an end part of the first linear element 1 (i.e., an end point at which the first linear element 1 extending in a first direction terminates). It is preferable for the glass antenna 100 to include an antenna element β used for L-band. The antenna element β includes a linear element 6 extending in the horizontal direction from the power-feed part 8. Although the antenna element α can receive L-band radio waves, the antenna element β may be provided as illustrated in FIG. 5 in a case where the gain of L-band is low.

The antenna conductor of the antenna element α may be bent to have its corner having a curvature. The end part of the antenna element α may be a part at which the antenna element α terminates. Alternatively, the end part of the antenna element α may be a conductive part positioned in the vicinity of the conductive part terminating before the end of the antenna element α.

In FIG. 2, a black shielding film 14 is formed on the surface of the window glass 11 used for a front glass of a vehicle. The antenna conductor of the antenna element α may be entirely or partly provided on the shielding film 14. The shielding film 14 may be formed of, for example, ceramic such as black ceramic. Owing to the shielding film 14, the antenna conductor provided on the shielding film 14 cannot be seen from the outside of the vehicle in a case where the window glass 11 is viewed from the outside of the vehicle. Thus, the window glass 11 has a satisfactory design. Because only the thin straight part of the conductor (part of antenna element α) can be recognized from the outside of the vehicle by forming at least a part of the power-feed part 8, the antenna α, or the antenna β on the shielding film 14, it is preferred to form at least the part of the power-feed part 8, the antenna α, or the antenna β on the shielding film 14 to attain a satisfactory design.

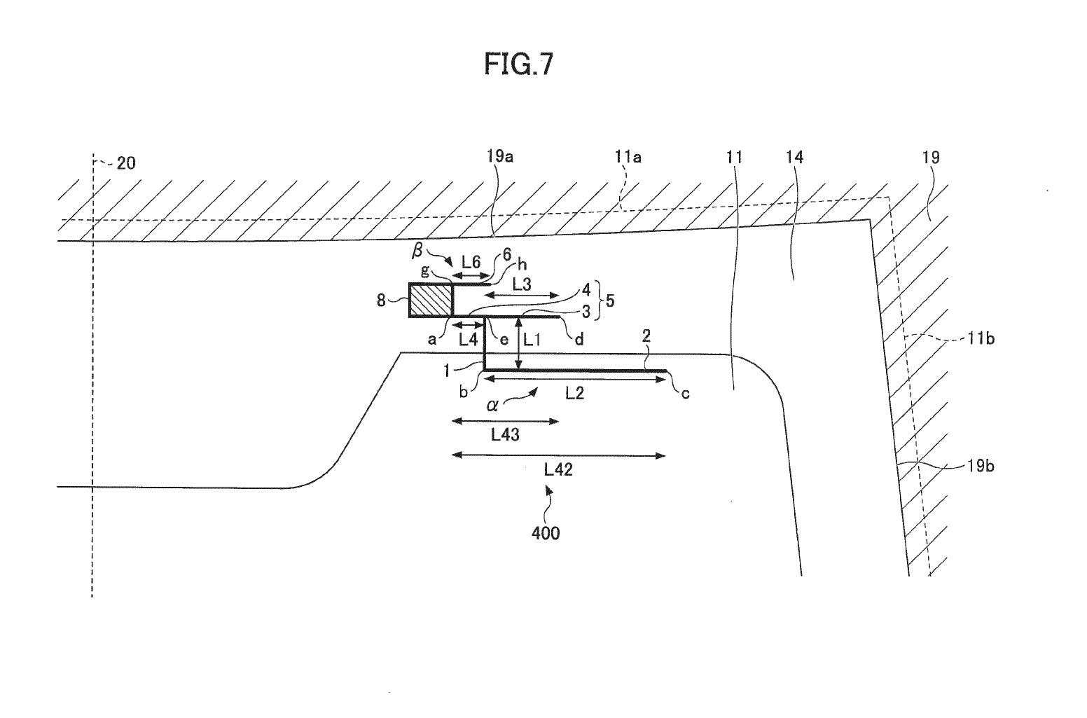

The shielding film 14 may have a projecting part 15 in the vicinity of a center line 20 of the window glass 11 relative to the width direction of the window glass 11, so that the below-described camera 22 can be mounted to the window glass 11 (FIG. 7).

The glass antenna (example of vehicle antenna) 100 is a monopolar antenna 100 that allows reception signals received by the antenna conductor to be extracted from a positive side (hot side) of the power-feed part 8 and transmitted to a receiver (not illustrated). In a case where the glass antenna 100 is a monopolar antenna, an opening (or its vicinity) of the vehicle on which the window glass 11 is attached is preferred to be a part that can be grounded (i.e., used as a ground of the vehicle body 19).

The glass antenna 100 is preferred to have the power-feed part 8 positioned in the vicinity of an upper edge part 19a of the vehicle body (e.g., metal body) 19.

The power-feed part 8 is a power-feed point (power-feed part) to which a power-feed line is electrically connected for connecting with a receiver (not illustrated). In a case where an AV (Audio Visual) line is used as a power-feed line, the power-feed part 8 is grounded by connecting the power-feed part 8 to an amplifier mounted on the side of the vehicle (power ground). In this case, the AV line can be easily attached to the power-feed part 8 by mounting a connector to the power-feed part 8 for enabling the connector to electrically connect the AV line and the power-feed line 8.

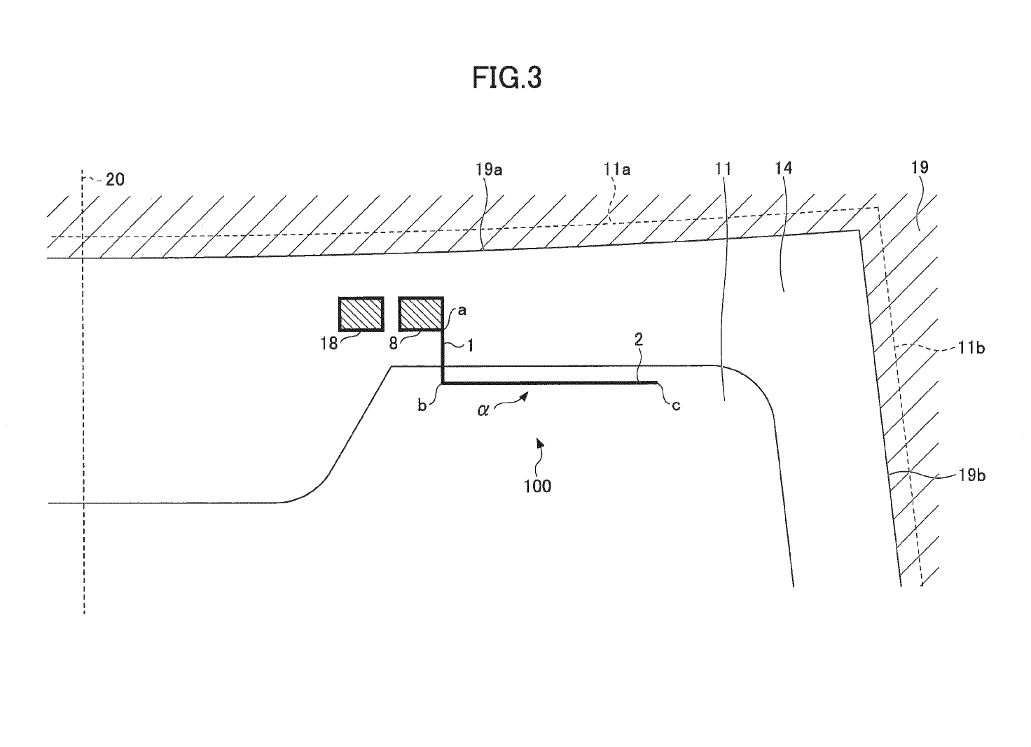

In a case where the power-feed part 8 is monopolar, only a single terminal base is mounted to the window plate 11 because no negative power-feed part is provided in the window glass 11. Therefore, the glass antenna 100 can easily be mounted to the vehicle. Further, manufacturing cost can be reduced because a contact point of the amplifier is reduced. However, as illustrated in FIG. 3, a ground part 18 may be mounted according to necessity.

In a case where the ground part (negative side power-feed part) 18 is mounted to the window glass 11, an internal conductor (core wire) of a coaxial cable is electrically connected to the power-feed part (positive side power-feed part) 8 whereas an external conductor of the coaxial cable is electrically connected to the ground part 18. The coaxial cable can easily be attached to the power-feed part 8 and the ground part 18 by mounting a connector to the power-feed part 8 and the ground part 18, so that the connector can electrically connect the coaxial cable to the power-feed part 8 and the ground part 18.

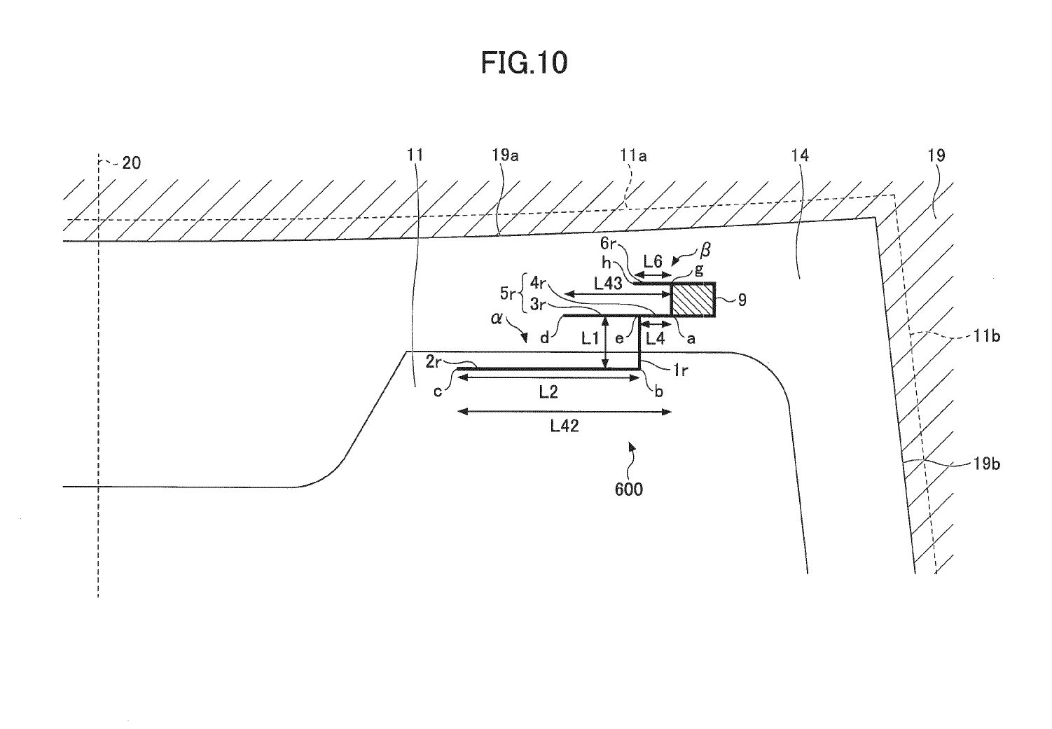

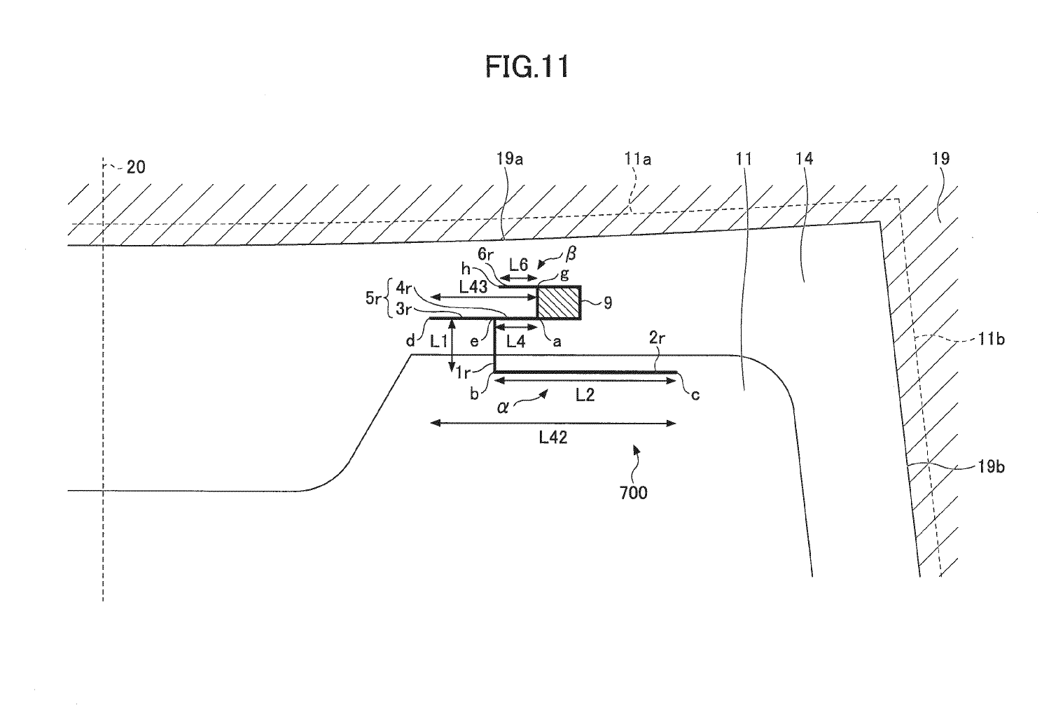

The ground part 18 is positioned near the periphery of the power-feed part 8 to prevent the ground part 18 from contacting the power-feed part 8 or the antenna element α, β connected to the power-feed part 8. In the embodiment of FIG. 3, the ground part 18 is positioned apart from the power-feed part 8 on the left side of the power-feed part 8. Alternatively, the ground part 18 may be positioned apart from the power-feed part 8 on the right side of the power-feed part 8 (see embodiments illustrated in FIGS. 10 and 11).

In a case where an amplifier circuit for amplifying reception signals extracted from the power-feed part 8 is installed inside a connector mounted to the power-feed part 8, the ground of the amplifier circuit is electrically connected to a ground part of, for example, the external conductor of the coaxial cable. Further, the power-feed part 8 may be electrically connected to the input of the amplifier circuit whereas the internal conductor of the coaxial cable may be electrically connected to the output of the amplifier circuit.

The shape of the power-feed part 8 may be determined according to the shape of a distal end of a power-feed line to be directly connected to the power-feed part 8 or the shape of a connecting device used for connecting a power-feed line and the power-feed part 8 (e.g., the shape of a mounting surface of a connector, the shape of a contact terminal). The power-feed part 8 may preferably have an orthogonal or a polygonal shape such as a quadrate, a substantially quadrangular shape, a rectangle, or a substantially rectangular shape. Alternatively, the power-feed part 8 may be a circle, a substantially circular shape, an ellipse, or a substantially elliptical shape.

Similar to the power-feed part 8, the ground part 18 illustrated in FIG. 3 may also take various shapes. Further, the distance between the power-feed part 8 and the ground part 18 may also be determined according to the shape of the distal end of the power-feed line to be directly connected to the power-feed part 8/the ground part 18 or the shape of the connecting device used for connecting the power-feed part 8/the ground part 18 and the power feed line.

The embodiment of FIG. 2 illustrates the power-feed part 8 having an orthogonal shape. A connection point “a” for connecting the power-feed part 8 and the antenna element α is positioned at a lower end of the right side of the power-feed part 8. A connection point “g” for connecting the power-feed part 8 and the antenna element “β” is positioned at an upper end of the right side of the power-feed part 8. Alternatively, the antenna elements α, β may be connected to the left side of the power-feed part 8 as illustrated in FIGS. 10 and 11. Alternatively, the power-feed part 8 may be connected to the antennas α, β in a horizontal direction in which the antenna elements α, β extend in opposite directions from the left and right sides of the power-feed part 8, respectively.

In the below-described embodiment, a composite resin film having a conductive layer may be formed on an outer surface (i.e., surface toward the outer side of vehicle) or an inner surface (i.e., surface toward the inner side of vehicle) of the window glass as a glass antenna by providing a conductive layer including an antenna conductor inside the composite resin film or on the surface of the composite resin film. Further, the glass antenna 100 may be fabricated by forming a flexible circuit substrate including an antenna conductor on an outer surface (i.e., surface toward the outer side of vehicle) or an inner surface (i.e., surface toward the inner side of vehicle) of the window glass 11.

Further, the “end part” of an element may be a point where the extension of the element starts (starting point) or terminates (terminating point). Alternatively, the end part of an element may be the vicinity of the starting point or the vicinity of the terminating point that is located before the starting point or the terminating point of the conductor part of the element. Alternatively, the connection parts that connect the elements together may be connected to form a curvature.

The antenna conductor is formed by printing a paste containing conductive metal (e.g., silver paste) on the vehicle inside surface of the window glass plate and baking the paste. However, the antenna conductor may be formed by using other methods. For example, a linear or a foil-like member made of a conductive material (e.g., copper) may be formed an outer surface (i.e., surface toward the outer side of vehicle) or an inner surface (i.e., surface toward the inner side of vehicle) of the window glass 11. The antenna conductor may be formed on the window glass by using an adhesive or the like. Alternatively, the window glass itself may have an antenna conductor provided therein. The power-feed part 8 and the ground part 18 may also be formed in the same manner.

In a case where the vehicle body 19 is formed of a metal material, the reception gain of the antenna tends to decrease as the antenna on the window glass 11 is positioned closer to the vehicle body 19. This is due to the interference between the metal of the vehicle body 19 and the metal of the conductive antenna in which the broadcast radio waves (particularly, Band III radio waves having a relatively low frequency) received by the conductive metal antenna leak out to the vehicle body 19.

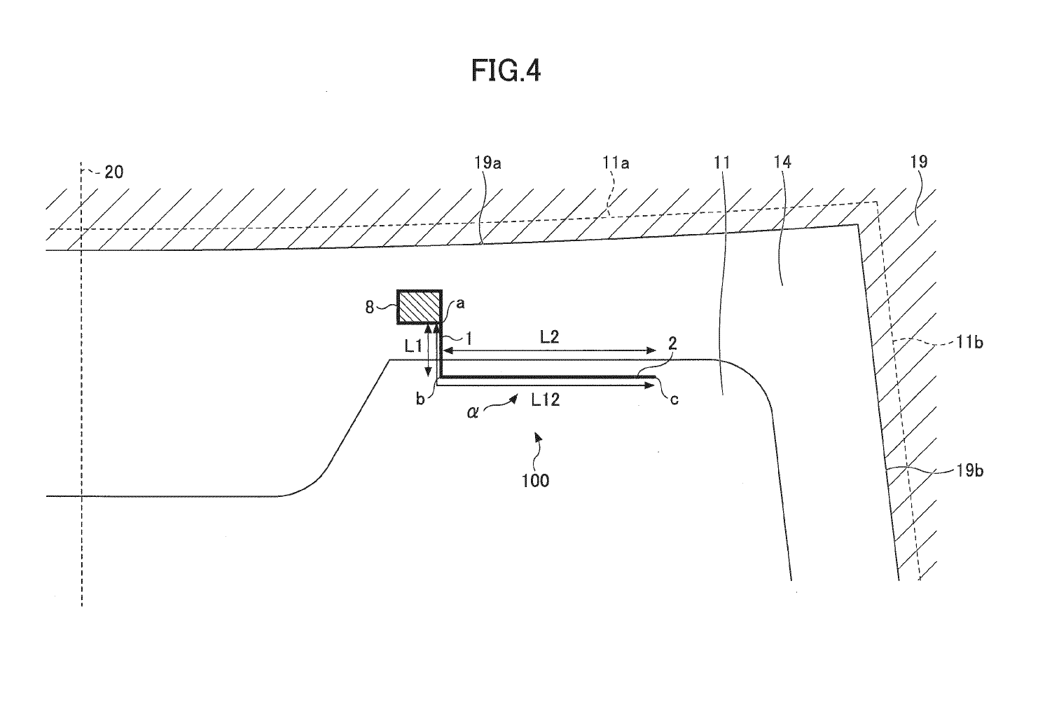

In any one of the below-described embodiments illustrated in FIGS. 4 to 7 and 9 to 11, the longest linear element (second linear element) 2 is connected to a lower end “b” of the element 1 extending in the vertical direction. Therefore, the longest element 2 having the largest influence on the performance of the glass antenna among the elements constituting the first antenna element α is positioned a predetermined distance apart from the upper edge part 19a of the vehicle body 19.

Because the frequency of L band received by the antenna element β is high, the antenna element β is relatively less susceptible to metal interference. Therefore, the antenna element β may be positioned near the upper edge part 19a to the extent of not contacting the upper edge part 19a. That is, the antenna element β is preferred to be closer to the upper edge part 19a than the antenna element α.

More specifically, the area for mounting the vehicle antenna 100 is in the vicinity of the upper edge part 11a and is in a range less than or equal to the length of the opening of the vehicle body 19 from the upper edge part 19a in the vertical direction. The area for mounting the vehicle antenna 100 is in a range that is less than or equal to 20% relative to the length of the opening of the vehicle body 19 from the upper edge part 19a in the vertical direction, and is preferably less than or equal to 200 mm from the upper edge part 19a, more preferably less than or equal to 150 mm, and yet more preferably less than or equal to 100 mm.

Further, the vehicle antenna 100 is preferred to be separated a predetermined distance from the upper edge part 19a of the vehicle body 19 but also a predetermined distance from the side edge part 19b of the vehicle body 19 for preventing interference with respect to the metal of the vehicle body 19.

### First Embodiment

FIG. 4 is a plan view of a vehicle window glass mounted with the glass antenna 100 according to the first embodiment of the present invention. FIG. 4 illustrates an upper right side area of the window glass (front glass) 11. In this embodiment, the glass antenna 100 includes the antenna element α extending from the power-feed part 8.

In the first embodiment, the element 1 of the antenna element α extends away from the upper edge part 19a in a substantially vertical direction starting from the connection point “a” connected to the power-feed part 8 and terminating at the lower end “b”. It is to be noted that the antenna element α is an example of the first antenna conductor, and the element 1 is an example of the first linear element. The element 2 of the antenna element α extends in a substantially horizontal direction starting from the lower end “b” of the element 1 and terminating at the end part “c”. The element 2 is an example of the second linear element. Among the multiple elements constituting the antenna element α according to the first embodiments and the embodiments illustrated in FIGS. 4 to 7 and 9, the element 2 extending in the horizontal direction extends in a direction separating from a center line relative to a horizontal direction of the window glass 11.

Accordingly, among the multiple elements constituting the antenna element α, the element 1 is provided in the window glass 11 to include a vector component that is orthogonal to a horizontal plane. Accordingly, the antenna element α can receive vertical polarized radio waves (e.g., Band III radio waves) more easily. The angle in which the window glass 11 is attached to the vehicle is, preferably, for example, 20° to 90° relative to the horizontal plane.

More specifically, among the vertical polarized radio waves in the DAB frequency band having a wide bandwidth, the wavelength on the window glass 11 is assumed as “λ_{g1}=λ₀₁·k” wherein the wavelength of the low band radio waves transmitted in the air in the central frequency of the first frequency band is “λ₀₁” and the wavelength shortening rate of the window glass 11 is “k”. The length of longest path from the power-feed part 8 to the tip of the first antenna element α (longest path length “La”) is targeted to a value of (¼) λ_{g1}. As long as the longest path length La is greater than or equal to ( 3/16)·λ_{g1} and less than or equal to ( 11/32)·λ_{g1}, satisfactory results can be attained for improving antenna gain in the second frequency band.

For example, the central frequency of Band III (170 MHz to 240 MHz) is 207 MHz. Thus, in order to improve antenna gain in Band III, the longest path length “La” is preferably adjusted to be greater than or equal to 174 mm and less than or equal to 319 mm assuming that the speed of the radio waves is 3.0×10⁸ m/s and the wavelength shortening rate “k” is 0.64.

That is, owing to the shape of the glass antenna 100, the longest path length “La” of the antenna element α is set to a length for resonating in the first broadcast frequency band. For example, in the embodiments illustrated in FIGS. 4 to 6, the longest path length “La” refers to the longest length of a conductor (also referred to as “element length”) starting from the connection point “a” and terminating at the end part “c” of the element 2 without overlapping the same element. That is, the length of a conductor having a path defined by ends “a”, “b”, and “c” in this order. In the embodiments illustrated in FIGS. 7, and 9 to 11, the length of the conductor has a path defined by ends “a”, “e”, “b”, and “c” in this order.

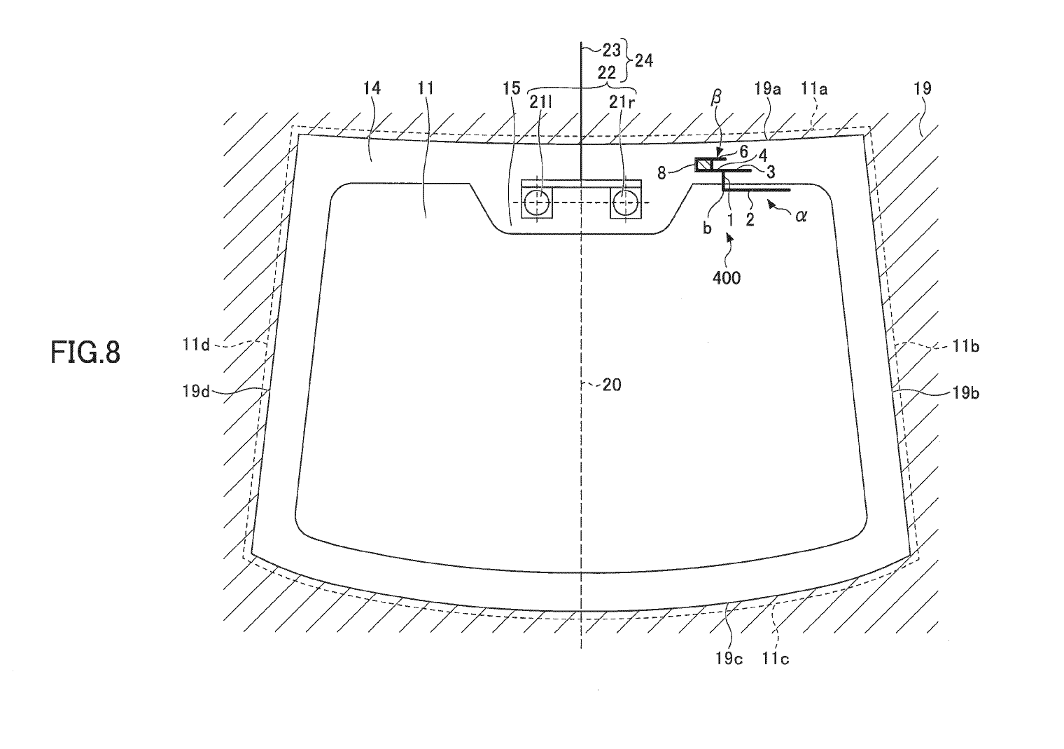

Because DAB uses vertical polarized waves, the reception gain improves as the distance of the conductor length L1 of the element (first linear element (vertical element)) 1 becomes longer. However, if the length L1 of the element 1 is too long, the antenna element α would protrude from the shielding film 14 and cause more parts of the antenna element α to become visible. This results in poor appearance from the inside and the outside of the vehicle. Further, in a case where the camera 22 is mounted as illustrated in FIG. 8, the lower end “b” (part nearest to the camera 22) of the element 1 would become too close to the camera 22 if the element 1 is extended too downward. This may degrade the gain of the glass antenna 100.

Accordingly, it is preferable to set a threshold of a quality for receiving broadcast waves and form the element 2 with a length (conductor length) L2 that is greater than 1 times the length (conductor length) L1 of the element 1 and less than or equal to 20 times the length L1 of the element 1.

### Second Embodiment

FIG. 5 is a plan view of a vehicle window glass mounted with a glass antenna (example of vehicle antenna) 200 according to the second embodiment of the present invention. FIG. 5 illustrates an upper right side area of the window glass (front glass) 11.

In comparison with the glass antenna 100 of FIG. 4, the glass antenna 200 of the second embodiment includes an antenna element (example of second antenna conductor) β in addition to the antenna element α extending from the power-feed part 8.

In the second embodiment, the antenna element β includes an element 6 extending in a substantially horizontal direction from a connection point g connected to the power-feed part 8 (i.e., direction parallel to the element 2) and terminating at one end h (i.e., end point at which the element 6 terminates). Further, the antenna element β extends in the same direction as the element 2.

It is to be noted that, the antenna element β is in non-contact with the antenna element α and receives vertical polarized waves of a frequency band different from the frequency band of the antenna element α. More specifically, the antenna element α receives broadcast waves of the Band III bandwidth whereas the antenna element β receives broadcast waves of the L-band bandwidth.

The antenna element β is an antenna element used for L-band digital audio broadcasting. Because the frequency for L-band is higher than the frequency for Band III, the antenna length of the antenna element β is significantly shorter than the entire length of the antenna element α. Therefore, the antenna element β is entirely arranged between a part of the element 2 and a portion of the upper edge part 19a.

Among the vertical polarized radio waves in the DAB frequency band having a wide bandwidth, the wavelength on the window glass 11 is assumed as “λ_{g2}=λ₀₂·k” wherein the wavelength of the low band radio waves transmitted in the air in the central frequency of the second frequency band is “λ₀₂” and the wavelength shortening rate of the window glass 11 is “k”. As long as the length of the antenna element β is greater than or equal to (⅛)·λ_{g2} and less than or equal to (⅞)·λ_{g2}, satisfactory results can be attained for improving antenna gain in the second frequency band.

For example, the central frequency of L-Band (1452 MHz to 1492 MHz) is 1472 MHz. Thus, in order to improve antenna gain in L-Band, the path length (longest length) of the antenna element β is preferably adjusted to be greater than or equal to 16 mm and less than or equal to 114 mm assuming that the speed of the radio waves is 3.0×10⁸ m/s and the wavelength shortening rate “k” is 0.64.

That is, owing to the shape of the glass antenna 200, the path length of the antenna element β is set to a length for resonating in the second broadcast frequency band (L-Band). For example, in the embodiment illustrated in FIG. 5, the conductor length “L6” refers to the length of a conductor starting from the end part “g” of the antenna element β and terminating at the end part “h” of the antenna element β.

In the second embodiment, the antenna element β (example of second antenna conductor) is mounted for improving the performance of the L-Band. However, a sufficient L-band performance can be attained without the antenna element β as described above in the first embodiment.

### Third Embodiment

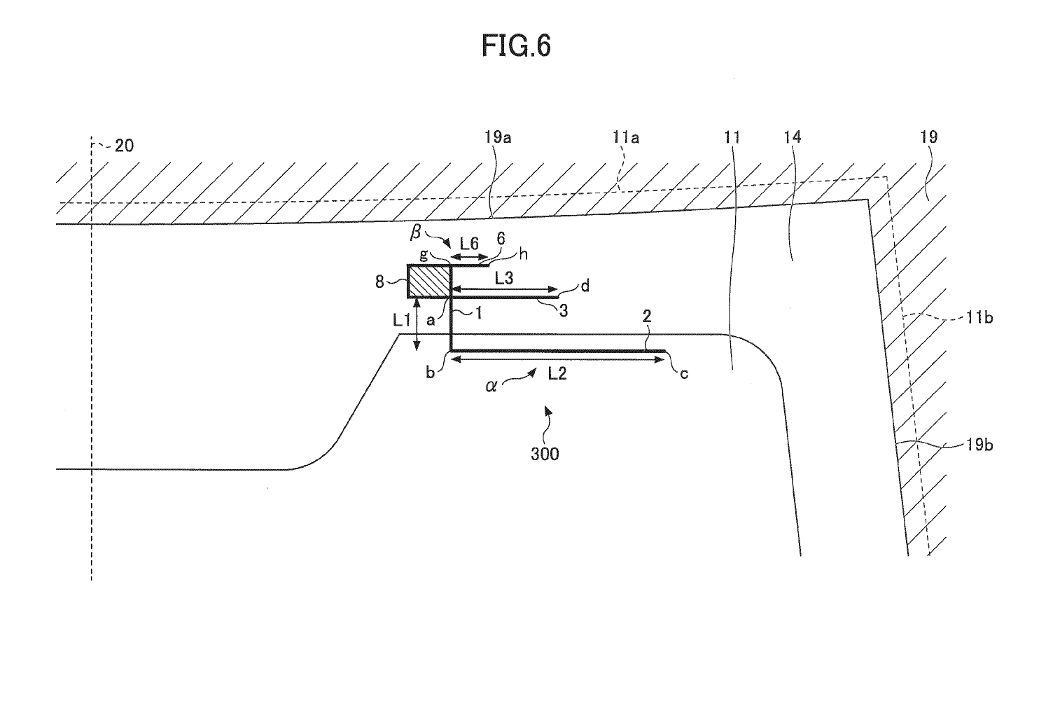

FIG. 6 is a plan view of a vehicle window glass mounted with a glass antenna (example of vehicle antenna) 300 according to the third embodiment of the present invention. FIG. 6 illustrates an upper right side area of the window glass (front glass) 11.

In comparison with the glass antenna 200 of FIG. 5, the glass antenna 300 of the third embodiment has an antenna element (example of first antenna conductor) α including an element (third linear element) 3 extending in a substantially horizontal direction from the power-feed part 8.

In the third embodiment, the element 3 shares the connection point “a” with the element 1 and the power-feed part 8. The element 3 extends in a substantially horizontal direction from the connection point “a” to be substantially parallel with the element 2.

Because each of the elements 1, 2, 3, and 6 of the glass antenna 300 is formed of a linear paste-like material including a conductive metal (e.g., silver paste), gain can be improved by the capacitive coupling caused by positioning the element 2 and the element 3 near each other in parallel.

However, in a case where the vehicle body 19 is formed of metal, the metal of the vehicle body 19 may cause interference if the element 3 is formed too long (L3) and positioned substantially close to the vehicle body 19. As a result, broadcast waves received by the antenna may leak to the vehicle body 19 and reduce the gain of the antenna.

In the third embodiment, the distance between the element 3 and the upper edge part 19a of the vehicle body 19 is shorter than the distance between the element 2 and the upper edge part 19a of the vehicle body 19. Thus, taking the interference of metal into consideration, the conductor length L3 of the element 3 is preferred to be shorter than the conductor length L2 of the element 2. It is more preferable for the conductor length L3 of the element 3 to be approximately half of the conductor length L2 of the element 2. Accordingly, the entire element 3 is positioned between a part of the element 2 and a portion of the upper edge part 19a, and the entire element β is positioned between a part of the element 3 and a portion of the upper edge part 19a.

### Fourth Embodiment

FIG. 7 is a plan view of a vehicle window glass mounted with a glass antenna (example of vehicle antenna) 400 according to the fourth embodiment of the present invention. FIG. 7 illustrates an upper right side area of the window glass (front glass) 11.

In comparison with the glass antenna 300 of FIG. 6, the glass antenna 400 of the fourth embodiment has an antenna element (example of first antenna conductor) α including a connection element (fourth linear element) 4 extending from the power-feed part 8.

The connection element 4 extends in a substantially horizontal direction from a lower end of the right side of the power-feed part 8 and terminates at an end part (connection point) “e”. The end part (connection) “e” is a point connecting the element 1 and the element 3.

The connection element 4 and the element 3 having the end part “e” as their connection point are arranged to form a straight line extending from the connection point “a” of the power-feed part 8 to the end point “d”. That is, the connection element 4 and the element 3 constitute a coupling element 5 extending substantially in the horizontal direction. Accordingly, the entire element β is positioned between a part of the coupling element 5 and a portion of the upper edge part 19a.

In the fourth embodiment, the connection point “e” provided at a terminating end of the connection element 4 functions as a branching point between the element 1 and the element 3. The element 1 starts extending from the connection point “e” between the connection element 4 and the element 3 in a substantially vertical direction away from the upper edge part 19a and terminates at the lower end (end point) “b”. That is, the element 1 is not directly connected to the power-feed part 8 but is connected to the power-feed part 8 by way of the connection point “e” serving as a terminating point of the connection element 4 and a starting point of the element 3.

In the fourth embodiment, the element 2 is not positioned directly below the power-feed part 8 but extends in a substantially horizontal direction from the lower end “b” of the element 1. In the fourth embodiment, the lower end “b” of the element 1 is moved horizontally (in the lateral direction of FIG. 7) away from the power-feed part 8 to the amount of the conductor length L4 of the connection element 4.

FIG. 8 is a schematic view of the entire front window glass of FIG. 7 that is mounted with the glass antenna 400 and the camera 22.

In recent years, many vehicles have a twin-lens distance measuring stereo camera mounted on its front window for improving vehicle safety. The camera mounted on the vehicle uses multiples cameras and calculates deviation of two images (benchmark image and reference image) of the same object taken by the multiple cameras and measures the distance of the object (e.g., person, vehicle, traffic light) based on the calculated deviation of the images. In order to evenly detect an object in front of the vehicle from the left and right sides, the camera tends to be mounted substantially at the center (relative to the horizontal direction) of an upper part of the front glass of the vehicle.

In a case of placing an antenna close to the camera mounted on the vehicle, there is a risk of decreasing the gain of the antenna. More specifically, the camera is not only used for processing images but is also used for transmitting information of images and distances obtained by the camera to a control part of the vehicle by way of, for example, signal lines, so that the control part can generate warning alarms inside the vehicle, track a preceding vehicle, or control the automatic brakes of the vehicle.

For example, in the example illustrated in FIG. 8, the camera (e.g., distance measuring camera) 22 is positioned to have imaging devices 21l, 21r symmetrically arranged in a lateral direction with respect to a center line 20 of the window glass 11. Further, the camera 22 is connected to a control line 23. As a result, the camera 22 and the control line 23 become a source of noise (noise source 24) influencing the glass antenna 400.

Therefore, the glass antenna 400 of the fourth embodiment is preferred to be mounted a predetermined distance away from the noise source 24 (particularly, the camera 22). Further, it is preferable to mount the glass antenna 400 a predetermined distance away from the side edge part 19b of the vehicle body 19 for preventing the side edge part 19b from influencing the glass antenna 400. Accordingly, in all of the embodiments of the present invention, the antenna conductor and the power-feed part are interposed between the center line 20 of the window plate 11 and the side edge part 19b of the vehicle body 19 and positioned a predetermined distance away from each of the center line 20 and the side edge part 19b.

In a case where the camera 22 and the noise source 24 such as the control line 23 are positioned in the vicinity of the center line 20, the element 1 according to the first to third embodiments of FIGS. 4 to 6 is directly connected to the power-feed part 8. Because the connection point “b” positioned closest to the camera 22 is directly below the power-feed part 8, the antenna element α is susceptible to noise from the camera 22.

However, because the connection element 4 is provided in the antenna element α of the glass antenna 400 of the fourth embodiment illustrated in FIG. 7, the connection point “b” positioned closest to the camera 22 is moved in the horizontal direction (moved rightward in FIG. 7) compared to the connection point “b” of the first to third embodiments. Thus, the connection point “b” is separated from the camera 22. Accordingly, the glass embodiment 400 of the fourth embodiment is more preferable than the glass antennas of the first to third embodiments illustrated in FIGS. 4 to 6 from the standpoint of preventing noise from the camera 22.

Nevertheless, excessively extending the connection element 4 would reduce the gain improvement caused by the capacitive coupling generated by the element 2 and the element 3 of FIG. 6 positioned near each other in parallel.

The influence of noise (gain decrease due to noise) exhibits a moderate decline as the antenna is positioned a predetermined distance away from the noise source 24. In contrast, the gain improved by capacitance coupling gradually changes in accordance with the lengths L2, L3 of the element 2 and the element 3 positioned near each other in parallel. Therefore, in comparison with the degree that the gain improves in the high frequency bandwidth, the gain in the low frequency bandwidth decreases more significantly as the conductor length L4 of the connection element 4 increases.

Accordingly, from the standpoint of preventing the gain from decreasing and improving the overall gain of the glass antenna 400, it is preferable to provide the connection element 4 in the antenna element α as the fourth embodiment and set the conductor length L4 of the connection element 4 to be less than or equal to 60% of the entire length L43 of the coupling element 5 including the element 3 and the connection element 4, and more preferably, approximately 10% to 40% of the entire length 43 of the coupling element 5.

Further, even in a case where the connection element 4 is provided in the antenna element α, the conductor length L43 of the coupling element 5 is preferred to be less than the length L2 of the element 2 from the standpoint of preventing interference by the vehicle body 19.

As a modified example of the fourth embodiment, the antenna element α may be formed without the element (third linear element) 3 and a branching point at the connection point “e” by bending the coupling element 5 in a substantially vertical direction from the connection element 4 and connecting the coupling element 5 to the element (first linear element) 1.

### Fifth Embodiment

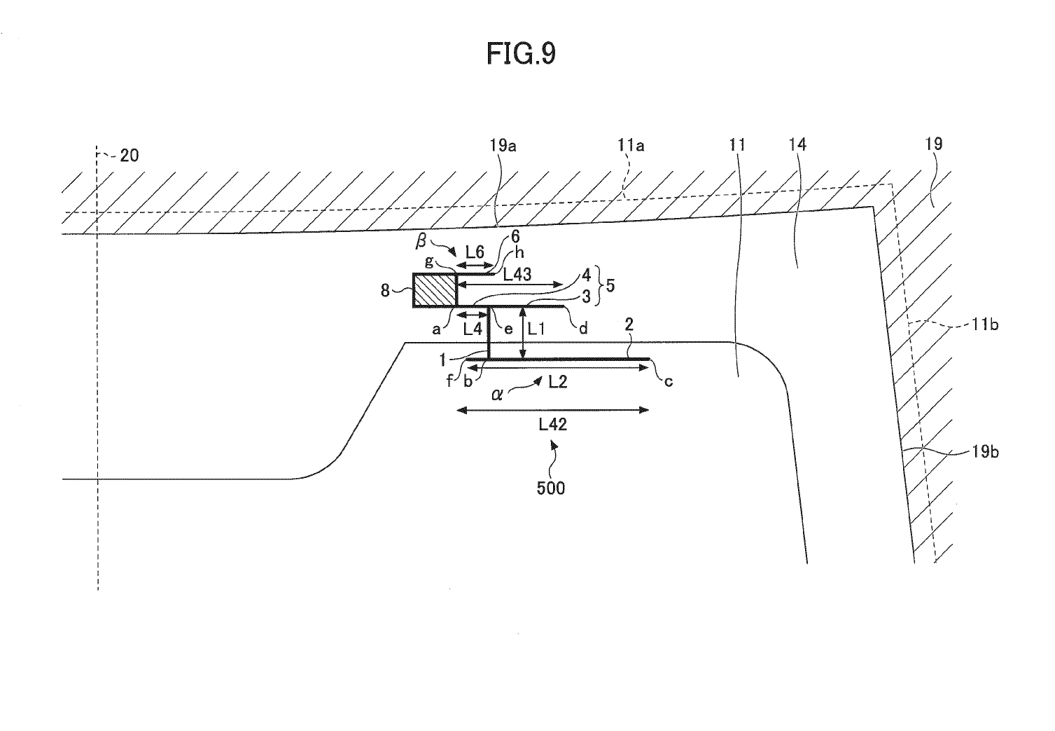

FIG. 9 is a plan view of a vehicle window glass mounted with a glass antenna (example of vehicle antenna) 500 according to the fifth embodiment of the present invention. FIG. 9 illustrates an upper right side area of the window glass (front glass) 11.

The glass antenna 500 of the fifth embodiment is different from the glass antenna 400 of FIG. 7 in that the element 2 extends toward the center line 20 from the connection point “b” connected to the element 1 and terminates at an end part “f”. Nevertheless, the glass antenna 500 of the fifth embodiment can also attain the same effects as the glass antenna 400 illustrated in FIG. 7.

### Sixth Embodiment

FIG. 10 is a plan view of a vehicle window glass mounted with a glass antenna (example of vehicle antenna) 600 according to the sixth embodiment of the present invention. FIG. 10 illustrates an upper right side area of the window glass (front glass) 11.

The glass antenna 600 of the sixth embodiment is different from the glass antenna 400 of FIG. 7 in that the glass antenna 600 is laterally inverted. The letter “r” is added to the reference numerals of the inverted elements. The power-feed part 9 of the sixth embodiment is positioned more toward the side edge part 19b of the vehicle body 19 than the antenna elements α, β. Nevertheless, the glass antenna 600 of the sixth embodiment can also attain the same effects as the glass antenna 400 illustrated in FIG. 7.

### Seventh Embodiment

FIG. 11 is a plan view of a vehicle window glass mounted with a glass antenna (example of vehicle antenna) 700 according to the seventh embodiment of the present invention. FIG. 11 illustrates an upper right side area of the window glass (front glass) 11.

The glass antenna 700 of the seventh embodiment is different from the glass antenna 600 of FIG. 10 in that the element 2r of the antenna element α extends toward the power-feed part 9 in the horizontal direction. That is, the element 2r is replaced to be linearly symmetrical with the element 2r of FIG. 10 relative to the element 1r of FIG. 10. Nevertheless, the glass antenna 700 of the seventh embodiment can also attain the same effects as the glass antenna 400 illustrated in FIG. 7.

Further, the glass antenna and the window glass of the present invention is not limited to the glass antenna and the window glass of the above-described embodiments, but variations and modifications may be made without departing from the scope of the present invention.

Next, the measurement results of the antenna gain of a vehicle glass antenna fabricated by attaching the glass antenna of the above-described embodiments to the window glass (front glass) of a vehicle are described.

The antenna gain is measured by attaching a vehicle window glass including a glass antenna to a window frame of a vehicle. The vehicle window glass was attached to the window frame placed on a turntable in a state tilted approximately 27.3° relative to a horizontal plane. The turntable was rotated so that radio waves are radiated to the window glass from all directions in the horizontal direction.

The power feed part of the antenna pattern serves as a network analyzer by way of an amplifier and a measurement cable. Each connection point was connected with a connector. The antenna pattern and the amplifier may be connector with a conductive elastic body (connection rubber).

The vehicle having the glass of the antenna attached thereto was rotated 360° in the horizontal direction to match the center of the vehicle. The data of the below-described examples were obtained by measuring antenna gain at every rotation angle of 3° in every 3 MHz in the frequency range of Band III. The antenna gain was measured in a state where the elevation angle formed by the radio wave radiating position and the antenna conductor is a substantially horizontal direction (i.e., a direction in which the elevation angle is 0° in a case where the elevation angle of the plane parallel to the ground is 0° and the elevation angle in the zenith direction is 90°). The antenna gain was measured with a half-wave dipole antenna as a criterion so that the antenna gain of the half-wave dipole antenna is normalized to become 0 dBd.

### First Example

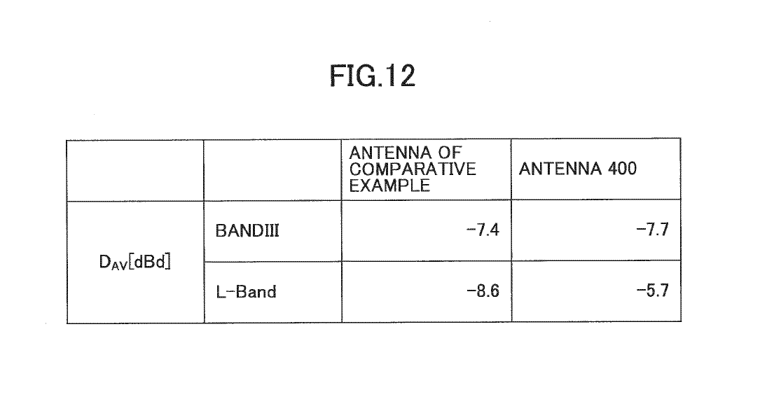

Next, the average gain of the glass antenna 400 of FIG. 7 and the average gain of a glass antenna 90 of a comparative example are described with reference to the table illustrated in FIG. 12.

In this embodiment, the horizontal elements of the antenna 700 are elongated horizontal patterns (lateral patterns) having the following dimensions indicated in millimeter units.

### L4: 40

### L3: 60

### L1: 45

### L2: 168

### L6: 35

It is to be noted that “L*” indicates the conductor length of an element “*”. The conductor width of each element is 0.8 mm. For example, the distance from the upper edge part 19a of a metal vehicle body 19 to the power-feed part 8 (antenna element β) of the vehicle body 19 is 5 mm. The shape of the power-feed part 8 is a rectangle having a length of 4 mm and a width of 20 mm.

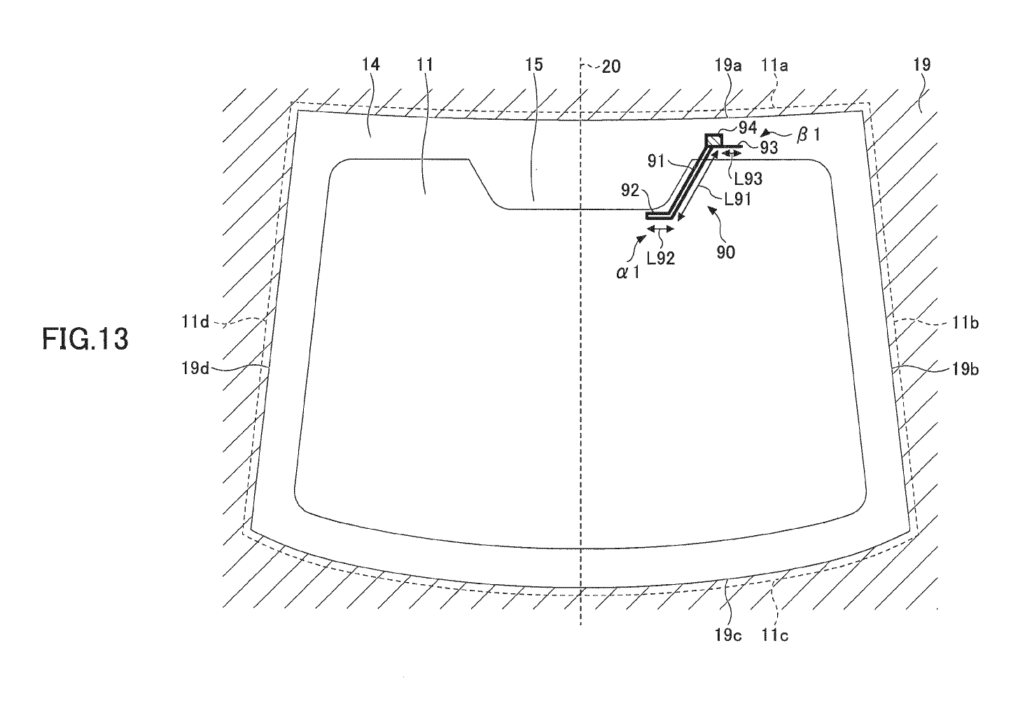

FIG. 13 illustrates a vertically oriented pattern serving as a comparative example relative to the first example. In the comparative example illustrated in FIG. 13, the glass antenna 90 has a vertical pattern and includes an antenna element α1 extending in a substantially vertical direction (direction extending along the projecting part 15 of the shielding film 14 of the window glass 11) and an antenna element β1 extending in a horizontal direction. The antenna element α1 is connected to a power-feed part 94 and includes an element 91 extending along the projecting part 15 of the shielding film 14 of the window glass 11 and an element 92 connected to a lower end of the element 91 and extending in a horizontal direction. The antenna element β1 includes an antenna element 93.

The dimension of each element of the glass antenna 90 of the comparative example of FIG. 13 is indicated in millimeter units as follows.

### L93: 100

### L91: 200

### L92: 59

The longest path length of the glass antenna 400 of the first example obtained by combining the elements L3, L1, and L4 is 253 mm whereas the longest path length of the glass antenna 90 of the comparative example obtained by combining the elements L91 and L92 is 259 mm. Accordingly, the conductor length of the elements of the first example embodiment and the conductor length of the elements of the comparative example are both within the range of 174 mm to 319 mm which is the range for improving antenna performance. Thus the influence of the difference of conductor lengths need not be taken into consideration.

As shown in FIG. 12, it can be understood that the average gain G of DAB for both the vertical polarized L-Band and Band III can be improved by the glass antenna 400 of this embodiment in comparison with the glass antenna 90 of the glass antenna 90 even in a case where the antenna 400 is formed having horizontal patterns.

### Second Example

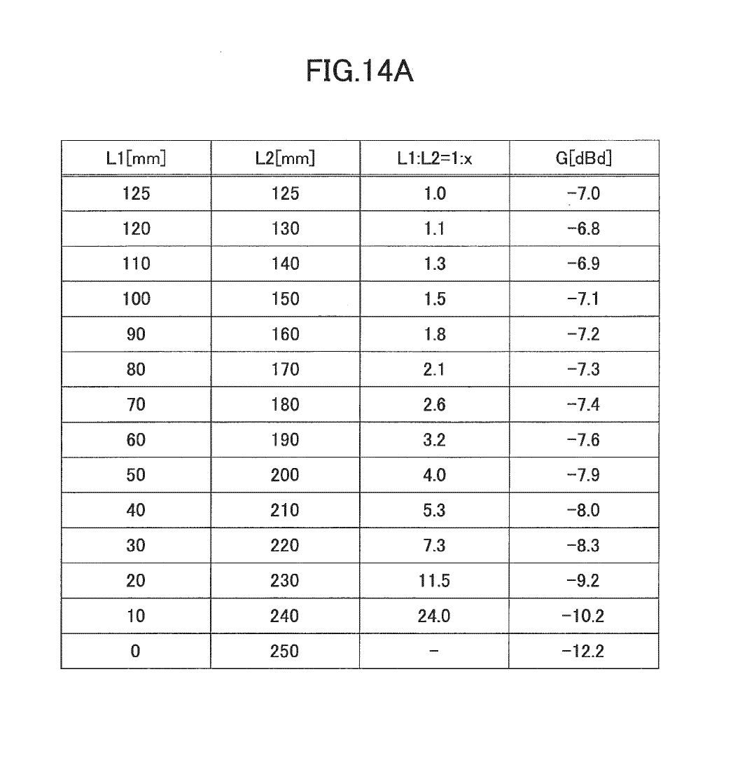

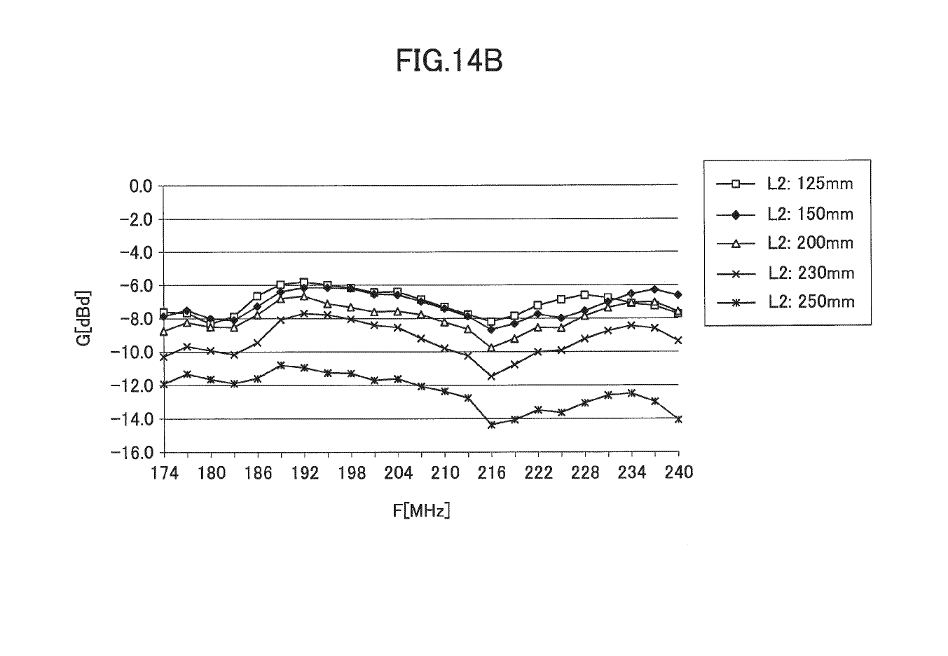

The table of FIG. 14A and the graph of FIG. 14B indicate the experiment data of a vehicle glass antenna fabricated by attaching the glass antenna 100 of FIG. 4 to the front glass of a vehicle. FIG. 14A illustrates the measured data of the ratio x between the conductor length L1 (length of the element 1 extending in the vertical direction) and conductor length L2 (length of the element 2 extending in the horizontal direction) and the average gain of the glass antenna 100. The measurement was performed by changing the ratios (aspect ratios) between the conductor length L1 and the conductor length L2 while the conductive length L12 (=L1+L2) is maintained at a fixed length of 250 mm, so that the conductor length L2 becomes larger.

FIG. 14B illustrates the average gain of Band III (170 MHz to 240 MHz) in a case where the conductor length L2 [mm] is changed from 125 to 150, 200, 230, and 250. In FIG. 14B, the horizontal axis indicates “frequency F” [MHz] and the vertical axis indicates “average gain G” [dBd]. The average gain indicates the average value of the antenna gains measured at every rotation angle of 3° in every 3 MHz in the above-described bandwidth.

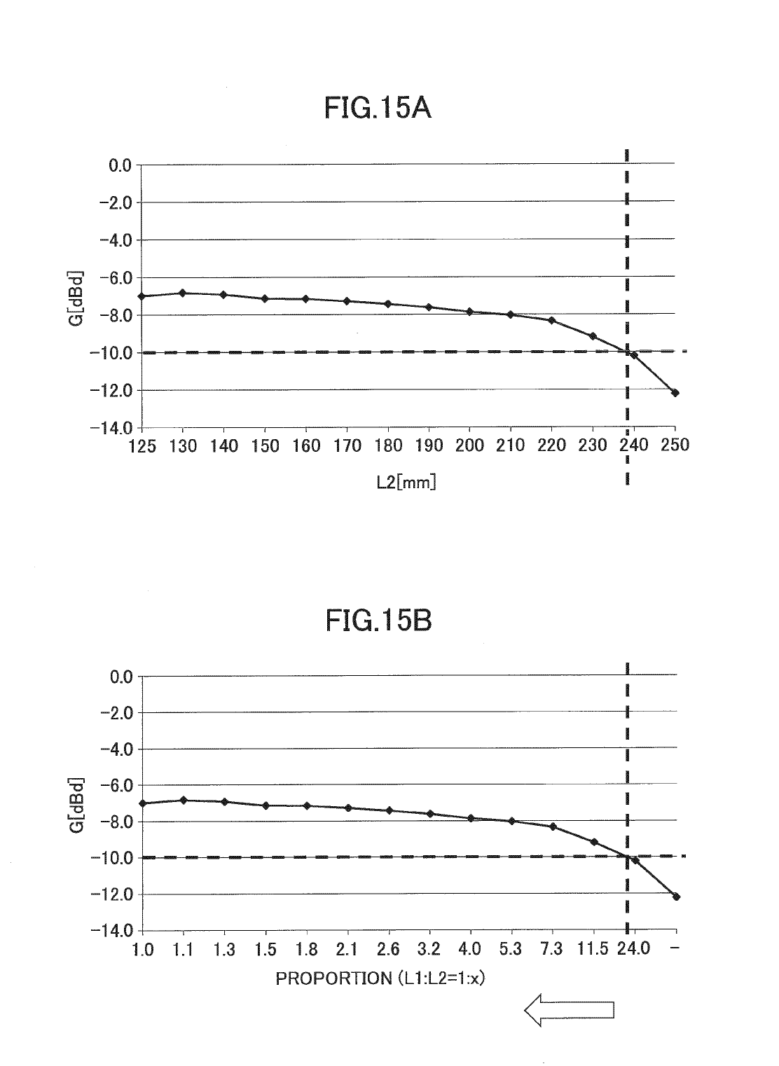

FIG. 15A is a graph illustrating the antenna gain with respect to the conductor length L2 of the element 2 in a case of changing the aspect ratios of the glass antenna 100 of FIG. 4. In FIG. 15A, the horizontal axis indicates “conductor length L2” [mm] and the vertical axis indicates “average gain G” [dBd]. FIG. 15B is a graph illustrating the average gain with respect to the ratio x of the glass antenna 100 of FIG. 4.

The dimensions applied for conducting the measurements in FIGS. 14A to 15B are the same as those of the first example except for the conductor length 12. It is, however, to be noted that the antenna element β is not provided in the second example.

In the second example, the longest path length La of the antenna is indicated as L12 (=L1+L2). By setting L12 to 250 mm, the longest path length La falls in a range of an optimum conductor length for receiving Band III which is greater than or equal to ( 3/16)·λ_{g1}, and less than or equal to ( 11/32)·λ_{g1}, that is, a range greater than or equal to 174 mm and less than or equal to 319 mm.

As described with FIGS. 14A to 15B, the gain of the antenna can be improved by the aspect ratio of the glass antenna in which gain improves as the length of the vertical element becomes longer.

In a case where the average gain is set to a minimum of −10 dBd as the threshold of the quality for receiving broadcast waves, the length of a horizontal element is preferred to be less than 240 mm in a case of using the antenna element of the above-described experiment having a total length of 250 mm. That is, the horizontal element is preferred to satisfy an aspect ratio of 1:24 or less with respect to the vertical element. More preferably, the aspect ratio is be 1:20 or less. It is yet more preferable for the aspect ratio to be much less than 1:20 such as the ratios “x” before the gain begins to significantly decrease as shown in FIG. 15B, so that the average gain can be further improved.

That is, the length (conductor length) L2 of the element 2 is preferably greater than 1 times the length (conductor length) L1 of the element 1 and less than or equal to 20 times the length L1 of the element 1.

### Third Example

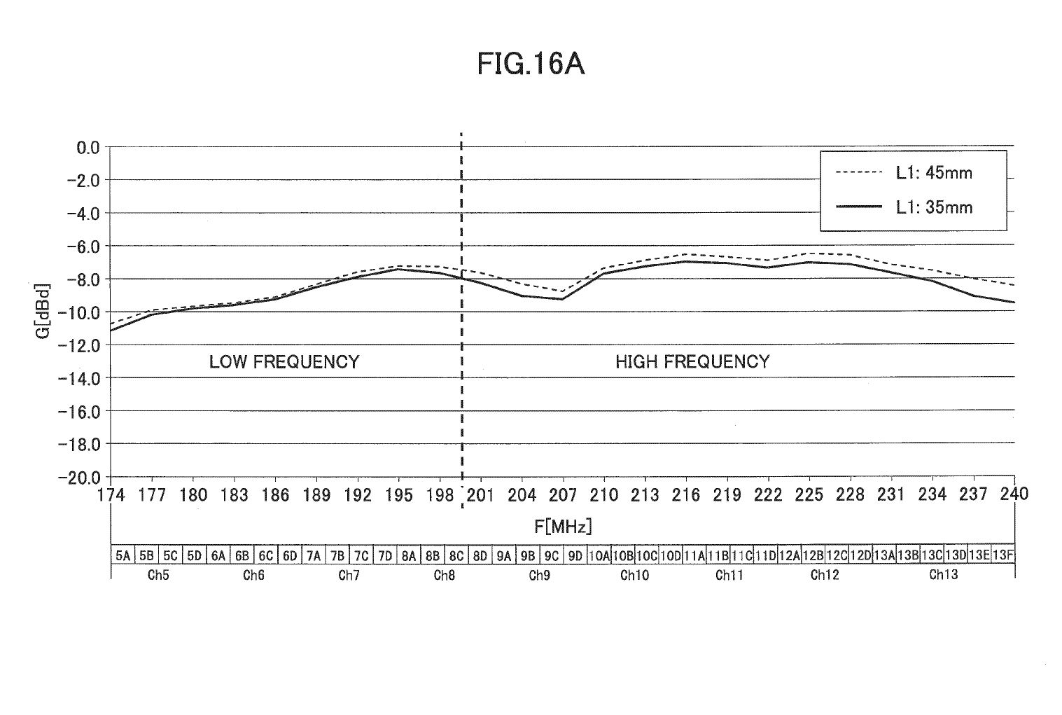

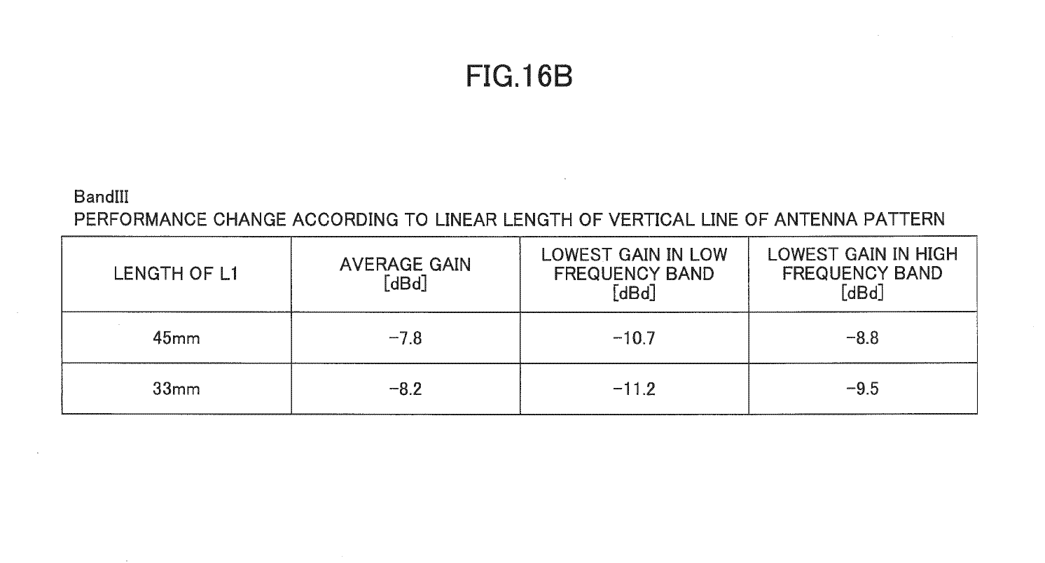

FIG. 16A is a graph illustrating another experiment in a case where the aspect ratios of antenna patterns are changed under conditions different from those of FIG. 14B. The graph of FIG. 16B indicates the experiment data of a vehicle glass antenna fabricated by attaching the glass antenna 400 of FIG. 7 to the front glass of a vehicle. The graph of FIG. 16A illustrates the measured data of the ratio “x” between the conductor length L1 (length of the element 1 extending in the vertical direction) and conductor length L2 (length of the element 2 extending in the horizontal direction) and the average gain of the glass antenna 400. The measurement was performed by changing the ratios (aspect ratios) between the conductor length L1 and the conductor length L2 while the conductive length L12 (=L1+L2) is maintained at a fixed length of 253 mm. FIG. 16A illustrates the average gain of Band III (170 MHz to 240 MHz) in a case where the conductor length L1 [mm] is changed to 45 and 35. In FIG. 16A, the horizontal axis indicates “frequency F” [MHz] and the vertical axis indicates “average gain G” [dBd]. The average gain indicates the average value of the antenna gains measured at every rotation angle of 3° in the above-described bandwidth.

FIG. 16B is a table illustrating the average gain and the lowest gain of the antenna with respect to each frequency in Band III.

The dimension of each part of the antenna used in the measurement of FIGS. 16A and 16B is indicated in millimeter units [mm] as follows. The dimensions other than the following are the same as the dimensions of the first example.

### L43: 100

### L4+L1+L2: 253

### L4: 40/52

### L1: 45/33

### L2: 168

### L42 (L4+L2): 208/220

### L6: 35

In the third example, the longest path length La is L412 (L4+L1+L2). Even in a case where the lengths L1, L2 of FIG. 5 are changed while the total length is maintained to a fixed length of 203 mm, the longest path length La remains to be 253 mm. Therefore, the longest path length La falls in a range of an optimum conductor length for receiving Band III which is greater than or equal to ( 3/16) λ_{g1} and less than or equal to ( 11/32)·λ_{g1}, that is, a range greater than or equal to 174 mm and less than or equal to 319 mm.

In comparing the configuration of the element (first linear element) 1 having a conductor length L1 of 33 mm and the configuration of the element 1 having a conductor length of 45 mm, the element 1 having a length of 45 mm can achieve a greater improvement of performance of the antenna compared to the element having a conductor length L1 of 33 mm.

Particularly, in comparison with the configuration having a length of 33 mm, the configuration having a length L1=45 mm has higher gain in the high frequencies of Band III (e.g., 8F to 13F band, that is, 199 to 240 MHz) which is used in many countries widely using DAB radio. More specifically, a comparison of gain performance in Band III is illustrated in FIG. 16B.

Regarding the correlation between the conductor length L1 of the element 1 extending in the vertical direction (same direction as vertical polarized wave of Band III in DAB), and the conductor length L2 of the element 2 extending in the horizontal direction, the proportion of the length of the element 1 is preferred to be greater than the length of the element 2 to the extent of not adversely affecting the appearance of the antenna even in a case where the element (third linear element) 3 and the element (fourth linear element, connection element) 4 are mounted to the antenna according to the results illustrated in FIGS. 16A and 16B.

### Fourth Example

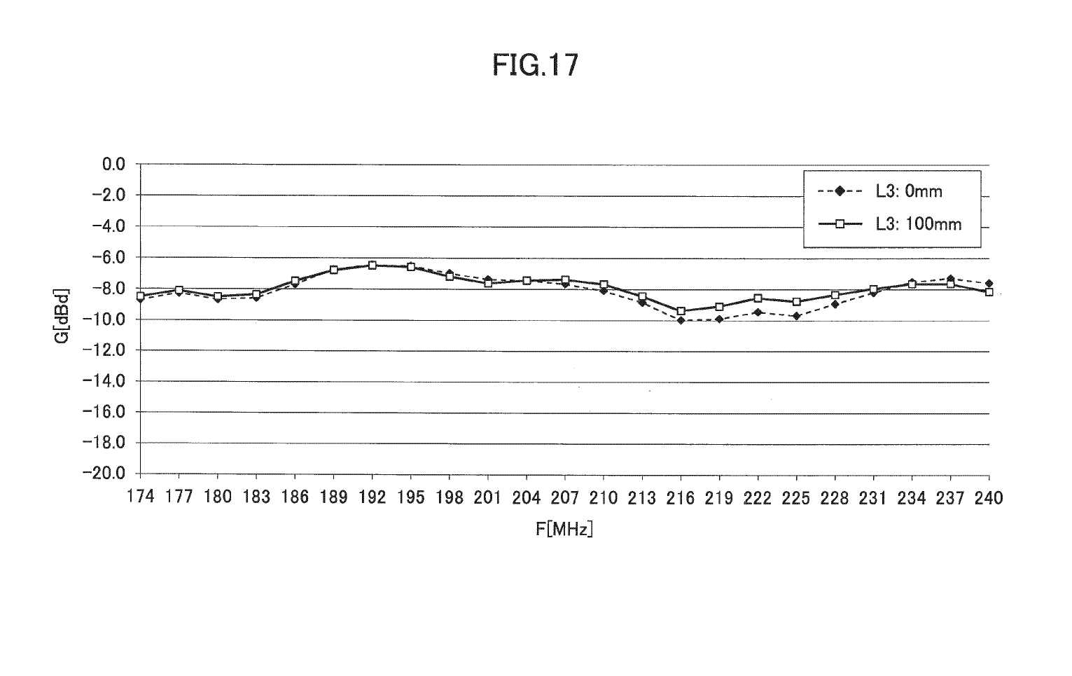

FIG. 17 illustrates the antenna gain of each frequency in Band III by comparing the glass antenna 200 of FIG. 5 and the glass antenna 300 of FIG. 6. That is, FIG. 17 illustrates the antenna gain of each frequency in Band III by comparing a case of adding the element (third linear element) 3 in the antenna and a case of not adding the element to the antenna. FIG. 17 illustrates the average gain of Band III (170 MHz to 240 MHz) in a case where the conductor length L3 [mm] is changed to 0 and 100. In FIG. 17, the horizontal axis indicates “frequency F” [MHz] and the vertical axis indicates “average gain G” [dBd]. The average gain indicates the average value of the antenna gains measured at every rotation angle of 3° in the above-described bandwidth.

The dimension of each part of the antenna used in the measurement of FIG. 17 is indicated in millimeter units [mm] as follows. The dimensions other than the following are the same as the dimensions of the first example. It is, however, to be noted that the antenna element β is not mounted to the antenna.

### L1: 50

### L2: 200

### L12: 250

### L3: 0/100

In the fourth example, the longest path length La is L12 (L1+L2). By setting the longest path length La to 250 mm, the longest path length La falls in a range of an optimum conductor length for receiving Band III which is greater than or equal to ( 3/16)·λ_{g1} and less than or equal to ( 11/32)·λ_{g1}, that is, a range greater than or equal to 174 mm and less than or equal to 319 mm.

By adding the element 3 extending the horizontal direction (lateral direction) to the glass antenna 300 of FIG. 6, the element 3 shows a greater improvement in average gain (particularly, in the bandwidth of 216 MHz to 231 MHz) compared to the performance of the glass antenna 200 of FIG. 5. For example, the element 3 shows a gain improvement of 0.9 dB in the 225 MHz bandwidth.

In the embodiment of FIG. 17 in which the element 2 has a conductor length L2 (=200 mm) longer than the conductor length L3 (=100 mm) of the element 3, the average gain was improved the most when the conductor length L1 of the element 1 is 50 mm and the conductor length L2 of the element 2 is 200 mm in the case where the conductor length L3 is set to 100 mm. In a case where the conductor length L3 is set to be greater than 100 m, the gain of the antenna decreases due to influence from the metal vehicle body 19.

Note that Band III is segmented into frequency blocks 5A to 13F. Various frequency blocks are used in countries widely using DAB radio. For example, Norway mainly uses a frequency block 8C and frequency blocks 11C to 13F, the United Kingdom mainly uses frequency blocks 10B to 12D, Denmark mainly uses frequency blocks 9B to 13C, and Australia mainly uses frequency blocks 9A to 10B. Therefore, high gain is desired for widely used bandwidths 8C to 13F of Band III, that is, the high frequency bandwidths of 199 MHz to 240 MHz in Band III.

By adding the element (linear element) 3 extending in the horizontal direction as the third embodiment illustrated in FIG. 6, FIG. 17 shows that the average gain can be improved particularly in the bandwidth of 216 MHz to 231 MHz. Because the gain can be improved for the frequency bandwidth used by many countries, the configuration of the third embodiment having the element 3 added thereto is more preferable compared to the configuration of the second embodiment.

### Fifth Example

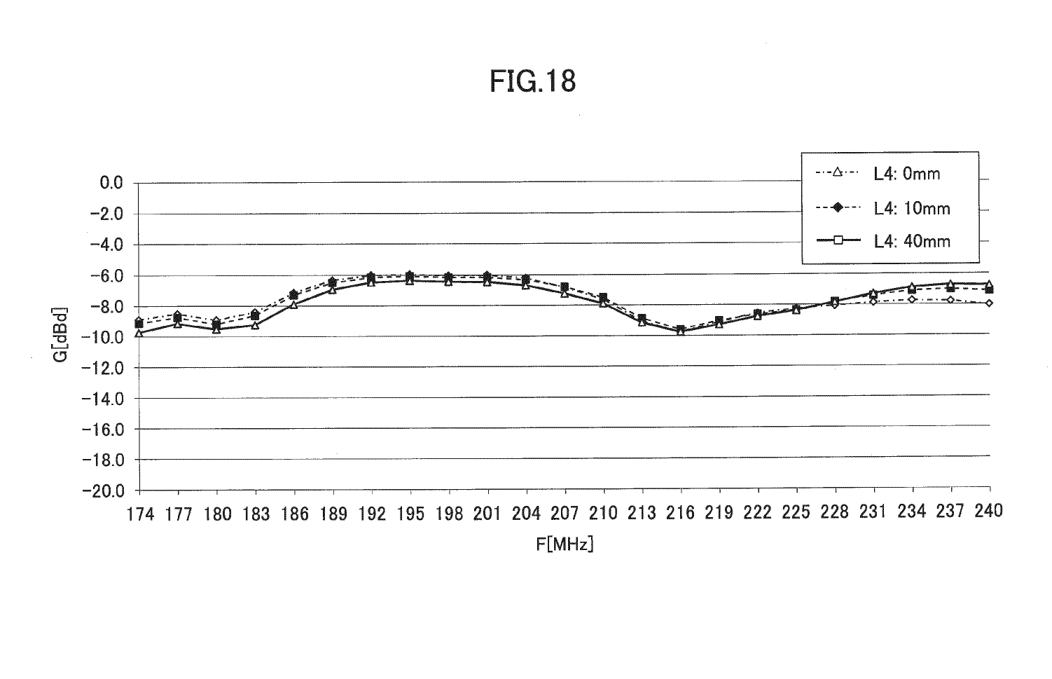

FIG. 18 is a graph illustrating the antenna gain of each frequency in Band III in a case where the branching position of an antenna pattern is changed. More specifically, FIG. 18 illustrates the measurement data of the antenna gain of a vehicle glass antenna fabricated by attaching the glass antenna 400 of FIG. 7 to the window glass 11 of the vehicle. In the measurement of FIG. 18, the branching position of the glass antenna 400 is changed by extending the length of the element 4 extending in the horizontal direction and shortening the length of the element 2 while maintaining the conductor length L42 (=L2+L4) to 200 mm. FIG. 18 illustrates the average gain in Band III (170 MHz to 240 MHz) in a case where the conductor length L4 is changed to 0 mm, 10 mm and 40 mm. In FIG. 18, the horizontal axis indicates “frequency F” [MHz] and the vertical axis indicates “average gain G” [dBd]. The average gain indicates the average value of the antenna gains measured at every rotation angle of 3° in every 3 MHz in the above-described bandwidth.

The dimension of each part of the antenna used in the measurement of FIG. 18 is indicated in millimeter units [mm] as follows. The dimensions other than the following are the same as the dimensions of the first example. It is, however, to be noted that the antenna element β is not mounted to the antenna.

### L42 (L4+L2): 200

### L1: 50

### L4+L1+L2: 250

### L2: 200/190/160

### L3: 100/90/60

### L4: 0/10/40

In the fifth example, the longest path length La is (L4+L1+L2), and the total length of L4 and L2 of the embodiment of FIG. 7 is 200 mm. Even if the proportion of L4 and L2 is changed as described above, the longest path length La remains to be 250 mm. Therefore, the longest path length La falls in a range of an optimum conductor length for receiving Band III which is greater than or equal to ( 3/16)·λ_{g1} and less than or equal to ( 11/32)·λ_{g1}, that is, a range greater than or equal to 174 mm and less than or equal to 319 mm.

As illustrated in FIG. 18, the average gain is comparatively low in the bandwidth of 231 MHz to 240 MHz in a case where the connection element 4 having a conductor length L4=0 does not branch and is directly connected to the element 1 at the power-feed part 8. As described above, because the bandwidth 231 MHz to 240 MHz is included the high frequency bandwidth of Band III used in many countries, improving the gain in this bandwidth is favorable.

For example, a connection element 4 having a conductor length L4 of 10 mm showed a gain improvement of 0.9 dBd in a bandwidth of 240 MHz in comparison with a connection element 4 having a conductor length L4 of 40 mm. Further, in the case where the conductor length L4 is 40 mm, the average gain relatively decreases in a bandwidth of 189 MHz. Accordingly, the conductor length L4 of the connection element 4 and the length L2 of the element 2 establish an inverse proportional relationship. That is, the gain in the high frequency band increases as the conductor length L4 of the connection element 4 increases while the length L2 of the element 2 decreases because the distance from a noise source becomes shorter. In contrast, the gain in the low frequency band decreases as the conductor length L4 of the connection element 4 increases while the length L2 of the element 2 decreases because the distance of capacitive coupling becomes shorter.

Therefore, providing a connection element as in this embodiment is preferred from the standpoint of preventing decrease of gain and improving the overall gain. Thus, it is preferred for the connection element 4 to have a conductor length L4 that is at least less than or equal to 60 mm. It is more preferably to set the connection length L4 to approximately 10 mm.

Further, in the case where the connection element 4 is provided, the total length of the connection element 4 and the element 3 is preferred to be shorter than the conductor length L2 of the element 2 from the standpoint of preventing interference from the metal vehicle body 19.

### Sixth Example

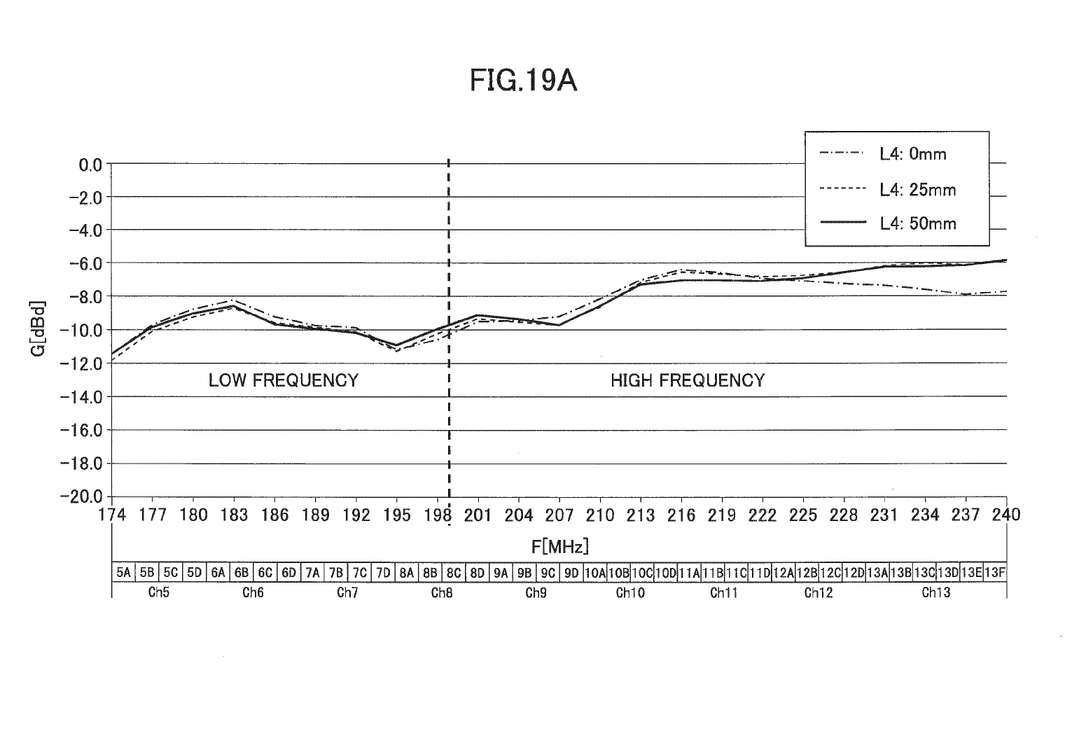

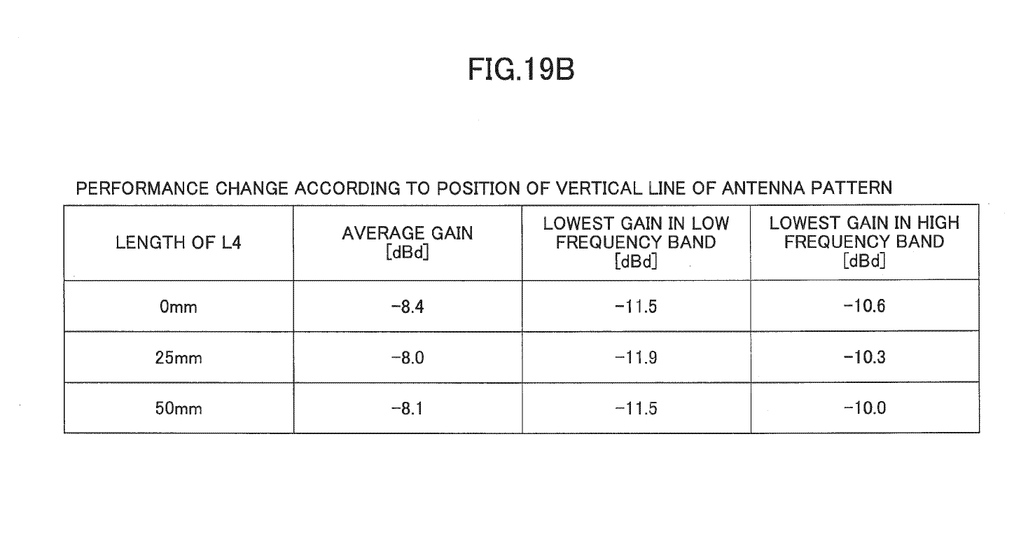

FIG. 19A is a graph illustrating a case where a branching position of an antenna pattern is changed and conditions are different from those of FIG. 18. FIG. 19A illustrates the average gain in Band III (170 MHz to 240 MHz) in a case where the conductor length L4 [mm] is changed to 0 mm, 25 mm and 50 mm. In FIG. 19A, the horizontal axis indicates “frequency F” [MHz] and the vertical axis indicates “average gain G” [dBd]. The average gain indicates the average value of the antenna gains measured at every rotation angle of 3° in every 3 MHz in the above-described bandwidth.

FIG. 19B is a table illustrating the average gain and the lowest gain of the antenna with respect to each frequency in Band III.

The dimension of each part of the antenna used in the measurement of FIGS. 19A and 19B is indicated in millimeter units [mm] as follows. The dimensions other than the following are the same as the dimensions of the first example.

### L43: 100

### L42 (L4+L2): 208

### L1: 45

### L4+L1+L2: 253

### L3: 100/75/50

### L4: 0/25/50

### L2: 208/183/158

### L6: 35

The measuring conditions of FIGS. 19A and 19B are different from those of FIG. 18 with respect to the arrangement of the ground of the camera having an influence on the performance of the antenna. That is, the waveforms illustrated in the graphs differ due to the difference in the arrangement of noise wires connected to the camera.

In the sixth example, the longest path length La is (L4+L1+L2). Even in a case where the lengths L4, L3, L1 of FIG. 7 are changed while the total length of L4+L1 is maintained to a fixed length of 208 mm, the longest path length La remains to be 253 mm. Therefore, the longest path length La falls in a range of an optimum conductor length for receiving Band III which is greater than or equal to ( 3/16)·λ_{g1} and less than or equal to ( 11/32)·λ_{g1}, that is, a range greater than or equal to 174 mm and less than or equal to 319 mm.

In comparing the configurations of the connection elements 4 having the conductor length L4 of 0 mm, 25 mm, and 50 mm, the connection element 4 having the conductor length L4 of 25 mm and the connection element 4 having the conductor length L4 of 50 mm show a greater improvement of performance than the connection element 4 having the conductor length of 0 mm.

By moving the position of the vertical line of the antenna toward the side edge part 19b, the performance of the antenna in the high frequency bandwidth improves. As illustrated in the measurement results of FIG. 19A, the influence of distance from the noise source appears in the high frequency bandwidth. As a tradeoff with the distance, the influence of shortening of the distance of capacitive coupling appears between the low and middle frequency bandwidths.

Therefore, it is most preferable when the connection element 4 of the sixth example has a conductor length L4 of 25 mm.

Hence, with the above-described embodiments of the present invention, there can be provided a vehicle antenna and a window plate including the antenna for improving the appearance of the antenna mounted to the window plate and enhancing the gain for receiving vertical polarized waves of DAB.

Further, the present invention is not limited to these embodiments, but variations and modifications may be made without departing from the scope of the present invention.

The present application is based on and claims the benefit of priority of Japanese Priority Application No. 2015-073469 filed on Mar. 31, 2015, with the Japanese Patent Office, the entire contents of which are hereby incorporated by reference.

What is claimed is:

1. A vehicle antenna included in a window plate mounted to an opening of a vehicle body of a vehicle, the vehicle antenna comprising:
a first antenna conductor; and
a power-feed part including a first connection point;
wherein the first antenna conductor and the power-feed part are positioned in a vicinity of an upper edge part of the opening and arranged between a side edge part of the opening and a center line of the window plate in a width direction of the window plate,
wherein the first antenna conductor includes
a first linear element extending in a vertical direction and including upper and lower ends, the upper end being directly connected to the first connection point or connected to the first connection point by way of a connection element, and
a second linear element extending in a horizontal direction and connected to the first linear element at the lower end or a vicinity of the lower end,
wherein a length of the second linear element is greater than a length of the first linear element.

2. The vehicle antenna as claimed in claim 1, wherein the window plate is a window plate provided at a front of the vehicle.

3. The vehicle antenna as claimed in claim 1, wherein the second linear element is positioned farther from the upper edge part than the power-feed part.

4. The vehicle antenna as claimed in claim 1, wherein the second linear element extends from the lower end of the first linear element in a direction separating from the power-feed part.

5. The vehicle antenna as claimed in claim 1, wherein the length of the second linear element is 1 times longer than the length of the first linear element and less than or equal to 20 times the length of the first linear element.

6. The vehicle antenna as claimed in claim 1, wherein the first antenna conductor further includes a third linear element extending from the upper end of the first linear element in a direction substantially parallel to the second linear element.

7. The vehicle antenna as claimed in claim 6,
wherein the upper end of the first linear element is connected to the power-feed part by way of the connection element,
wherein a total of a length of the connection element and a length of the third linear element is less than the length of the second linear element.

8. The vehicle antenna as claimed in claim 1, further comprising:
a second antenna conductor extending in the horizontal direction from a second connection point different from the first connection point of the power-feed part,
wherein the second antenna conductor is in non-contact with the first antenna conductor.

9. The vehicle antenna as claimed in claim 8, wherein each of the first antenna conductor and the second antenna conductor is configured to receive a vertical polarized wave of a different frequency bandwidth than the other.

10. The vehicle antenna as claimed in claim 1,
wherein the power-feed part is a positive power-feed part,
wherein no negative power-feed part is provided in the window plate.

11. A window plate comprising:
the vehicle antenna of claim 1.
